(19) United States
(12) Patent Application Publication
(10) Pub. No.: US 2006/0187805 A1
(43) Pub. Date: Aug. 24, 2006

(54) Method for production of an optical disc with a detachable module

(76) Inventors: Lars Lind, Hals (DK); Soren Feder, Aalborg (DK); Hennig Sogaard, Aslborg (DK); Lennart Vendelbjerg, Risskov (DK)

Correspondence Address: HARNESS, DICKEY & PIERCE, P.L.C., P.O.BOX 8910, RESTON, VA, 20195, US

(21) Appl. No.: 10/468,481

(22) PCT Filed: Feb. 22, 2002
(86) PCT No.: PCT/DK02/00122

§ 371 Date: Jan. 6, 2006

(30) Foreign Application Priority Data
Feb. 22, 2001 (DK) PA 2001 00297

(51) Int. Cl. G11B 7/26; B29D 11/00

(52) U.S. Cl. 369/273; 264/1.33; 264/2.5; 425/542; 425/810

(57) ABSTRACT

Method for production of an optical disc with a detachable module, where a standard mould is provided with an insert insertable into said standard mould. The insert restricting the internal dimensions of the mould cavity for shaping the optical disc into dimensions different from a standard optical disc. The insert comprises a line restrictor for providing a groove along at least one breaking line between the optical disc and the detachable module.

### FIELD OF THE INVENTION

The present invention relates to the production of an optical disc with a detachable module. The invention also relates to an embodiment of such an optical disc with a detachable module.

### DESCRIPTION OF PRIOR ART

Optical discs (CD, MiniDisc, CD-ROM, Digital Video Disc) are typically produced by injection moulding with a so-called stamper in a mould form. Such a process is described in European patent 296 677 by Cools and assigned to Philips. For the production of the stamper, a glass plate is covered with a resin that is laser illuminated and developed. Subsequently, the resin is covered with a metallic layer, typically Nickel, by sputtering and galvanic processes. The Nickel stamper is then removed from the glass and can after removal of the resin be used as a mould form in mould processes for optical disc production.

Typically, the stamper is adapted to the diameter of the mould form which normally is slightly larger in diameter than the final optical disc. In the mould form, the stamper is centered and fixed to ensure high accuracy during the moulding procedure. The mould is then closed and polymer, typically polycarbonate or PMMA (polymethylmethacrylate), is injected into the form at a temperature substantially over the melting temperature of the polymer, typically 340° C. for polycarbonate. The temperature has to be on the one hand lower than the temperature where the polymer start disintegrating and on the other hand so high that the polymer flows quickly in the mould form in order to avoid too large strain in the optical disc when it is removed from the mould.

Electronic modules like SIM plugs may be integrated in such optical discs. Such combinations are known from German patent application DE 199 05 588 by Bierlich assigned to Deutsche Telekom AG. In order to be able to remove the electronic module easily from the remaining carrier card with optical disc, a number of solutions have been proposed, for example in German Utility Model DE 201 02 719U by C.U.B.A. and in German patent application DE 199 43 092 by Lüke assigned to Orga. Neither of these two documents disclose a possible method for production of the disclosed optical disc with electronic module.

The term optical disc has to be understood in a general sense as a digital data carrier with optically readable data tracks, even though the shape of the digital data carrier may have shapes that differ from a circular form.

In German Utility Model DE 201 02 719U by C.U.B.A., a SIM plug can be removed from the optical disc by breaking two connecting bridges. However after breaking, the remaining SIM plug will have remains from the bridges such that the edge with the broken bridges is not smooth. The tolerances for the size of SIM plugs to be used in telephones are narrow such that the SIM plug as described in this document is not suited for ordinary usage.

In German patent application DE 199 43 092 by Lüke, a separation line can be broken to separate an electronic module from an optical disc. This optical disc with the module is produced by injection moulding, where the thickness of the electronic module is different from the thickness of the optical disc. However no clear advice is given for how to produce such an optical disc. In fact, a number of precautions have to be taken for such a process as will be apparent in the following, which is a reason why, so far, no such products are commercially available.

A general aim for a product where an electronic module like a SIM plug is connected to an optical disc, which then functions as a carrier, is to observe the ISO 7810 standard. The ISO 7810 standard governs the position for the placement of the SIM plug on such a carrier, where the carrier according to this standard has a length of 85.6 mm and a width of 53.9 mm—which is the standard size of a credit card. Electronic modules on cards of ISO 7810 standard, for example as described In European Patent EP 495 216 by Blome and Freise assigned to Orga, are well known to produce because such cards are used in telephones, especially elder telephones, in parallel to SIM plugs. Normally, the cards are prefabricated, after which a SIM electronic circuit is placed on the card in other existing machines. The configuration of the electronic circuit is governed by another standard, namely the ISO 7816. Such other existing machines producing electronic circuits on such prefabricated ISO 7810 carriers are not suited for the production of most known optical discs with SIM plugs, because the fixed placement according to ISO 7810 of the SIM plug on the carrier card and the size of the SIM plug itself leaves not enough space for the optical disc tracks to contain data. This is a problem faced by the shown embodiments in German patent application DE 199 43 092 by Lüke and assigned to Orga. A way to overcome this difficulty is a complete new construction of production machines for placement of the electronic module. The difficulty with the placement of the SIM module on an ISO 7810 standard card with an optical disc Is one of the problems to be solved.

In the aforementioned German patent application DE 199 43 092 by Lüke, there is no stated restriction on the actual size and shape of the optical disc with the SIM plug. However, the disclosure should be seen in the light of existing standards, for example the ISO 7810 standard that is mentioned in this German patent application. Also, though not restricted to the shape of the card in this document, only quadratic optical disc's are shown to which a SIM plug is attached. It is also mentioned in this document, that the quadratic form is preferred with an edge of 54 mm. This combination of features leads to another problem, namely that the diagonal length of the carrier card with the optical disk is 76 mm, which is 4 mm shorter than the minimum length required for a CD to be played in a large number of optical CD drive unit. For example, a CD of less than 80 mm will only be read properly in 60-70% of existing CD drive units. Thus, also in this respect, German patent application DE 199 43 092 gives no clear advice for how to construct a satisfactory CD with SIM plug. This is another problem to be solved.

It is the purpose of the invention to provide a method for production of an optical disc with a detachable module, for example an electronic module and preferably a SIM plug, where the module after detachment has a smooth edge. Especially, it is the further purpose of the Invention to provide a product that functions properly.

### DESCRIPTION/SUMMARY OF THE INVENTION

This purpose is achieved with a method according to the invention as described in the following.

A method is herewith disclosed for production of an optical disc with a detachable module, the method comprising the provision of a mould with mould cavity having internal dimensions corresponding to the dimensions of an optical disc with the detachable module, said mould having supplier means for supplying molten polymer into the mould. A stamper is provided in the mould cavity, said stamper having a surface towards the interior of the mould cavity, said surface having a surface structure being the counterpart for the corresponding surface structure of the moulded optical disc. Molten polymer is supplied into the mould cavity, said molten polymer filling the remaining space inside the mould cavity, after which the polymer is cooled to a temperature where the polymer is hardened. Finally the moulded optical disc is removed.

In order to establish a smooth, preferably linear, groove for a breaking line between the optical disc and the detachable module, a line restrictor is provided restricting the thickness of the optical disc with detachable module along at least one breaking line between the optical disc and the detachable module.

By providing a line restrictor according to the invention, it is not necessary to perform any milling action along this line for establishing a linear groove, which facilitates the production process tremendously as compared to known processes. An optical disc with detachable module is in this way according to the invention produced in one step with a precise shaping during the moulding process.

The method according to the invention may as well comprise the provision of a thickness restrictor for restricting the thickness of the detachable module, for example to 0.85 mm, in an area that is intended to include an electronic circuit.

In as far as the detachable module is or contains a SIM plug, the thickness of the SIM plug will be between 0.8 mm and 0.85 mm in order to fulfill thickness requirements, whereas the thickness of the optical disc is typically 1.2 mm. Optionally, already during the moulding, the detachable module is produced thinner than the optical disc.

As explained in the introduction with reference to European patent EP 296677 and references therein, there exist standard moulds for standard optical discs. In order to use these standard moulds, it has turned out that it is very advantageous to provide an insert which is insertable into such standard moulds, where the insert restricts the internal dimensions of the mould in order to shape the optical disc differently from a standard optical disc.

This insert may be shaped such that the optical disc is not circular but has other shapes, for example quadratic or rectangular. The insert may also comprise a module restrictor for restricting the thickness of the detachable module.

As far as the detachable module comprises a SIM plug, the SIM plug itself may have a thickness of 0.8 mm and comprises in addition a hollow in the SIM plug into which the electronic circuit is replaced. The module restrictor according to the invention may take account for the simultaneous production of this hollow in the SIM plug.

The line restrictor inside the mould reduces the speed at which the polymer may flow across the line restrictor. Because the distance between the edge of the restrictor and the opposite internal side of the mould is only spaced a short distance, the polymer is prevented from flowing across the line restrictor as freely as in the rest of the mould cavity. Therefore, temperature differences may occur across the hardening optical disc with detachable module which again may result in strain inside the hardened optical disc. This may have the consequence that the optical disc with the detachable module bends, when removed from the mould resulting in a non-satisfactory product.

In order to minimize such temperature differences when the polymer is injected into the mould and flowing inside the mould to fill the cavity completely, the invention has foreseen a further development, where the line restrictor is comprised by a movable plunger in order to establish the breaking line. Such a plunger is preferably moved in a direction approximately orthogonal to the optical disc into the mould cavity. This action is performed after having supplied polymer into the cavity and before this polymer hardens. As the line restrictor is not inside the cavity during the filling of polymer into the mould, the polymer can flow freely inside the remaining cavity such that temperature differences across the polymer in the cavity is avoided. Still being a fluid, the plunger in the form of a line restrictor is inserted and forms the groove for the breaking line between the detachable module and the optical disc. Though only one line restrictor and one plunger is mentioned in the foregoing and the following, this has to be understood also such that more than one line restrictor and plunger may be provided and used.

The detachable module that may be used for a SIM plug as mentioned earlier which has to be provided with a hollow for insertion of an electronic circuit. Also such a hollow can be produced by a plunger that is inserted into the cavity. Typically, a SIM plug has one hollow for the electronic circuit and inside this hollow a second, deeper hollow for attaching the electronic circuit to the SIM plate. This means that the material thickness of the polymer of the SIM plug at the thinnest is 0.2 mm. This implies in practice, if the mould form is solid without a plunger, that polymer has to flow between two faces of 0.2 mm distance. In such a narrow region, the polymer may cool faster than in the rest of the cavity, which may induce stress in the optical disc with a detachable module as describe earlier. By using a plunger to form this deep second hollow in the SIM plug such a too-fast-cooling is avoided.

For the amount of polymer to be injected into the mould, the volume of the plungers is taken into account.

By using plungers to provide grooves for breaking lines and, optionally, a hollow in the detachable module, the tolerances for injection speed of the polymer, for the time for the moulding process, for the pressure on the polymer and for the cooling time are much less strict than in corresponding processes without such plungers.

Once the optical disc has been removed from the mould, a reflective layer, typically a nickel layer, is provided on that side of the optical disc which has been facing the stamper. On top of this reflecting layer, a coating is applied. On standard optical discs such coating is spun on the surface after which a print is provided on the surface coating.

For a disc with detachable module according to the invention, such a spinning method is not optimal, because the coating may accumulate in the groove for the breaking line. Therefore, in a further development of the invention, it is foreseen that the surface coating is applied by spraying or by silk screen printing. It has turned out that spray-coating has another advantage as compared to spun coating as will be apparent in the following. A spun coating has typically a layer thickness 50 μm. Because a SIM plug has a very well-defined thickness, a 50 μm spun coating on the surface would imply that the polymer thickness between the glue in the hollow of the electronic module and the spun coating is only 0.15 mm, which is very thin and which easily may lead to deformation of the SIM plug during moulding and also during hardening of the spun coating and the applied glue inside the hollow. By applying spray coating, the coating on the SIM plug can be made thinner or be completely avoided, such that the wall thickness is not 0.15 mm but 0.2 mm, which results in a higher stability against bending of this thin wall.

The spray-coating that is applied to the reflective side of the optical disc may be an ultra violet hardening coating or varnish. It should be non-corrosive for the reflective layer, for example nickel coating or aluminum coating.

The injection moulding device for manufacturing optical discs with a detachable module from a polymer material according to the invention comprises a mould with a first and second mould section which are movable relative to another between an open and closed position. Between the first and second mould section in a closed position, a mould cavity is defined into which a moulding polymer is injectable to form the disc with the detachable module. The injection moulding device comprises a stamper in the mould cavity having a surface towards the interior of the cavity. The surface of the stamper has a surface structure being the counterpart for the corresponding surface structure of the moulded optical disc. The injection moulding device furthermore comprises at least one line restrictor for restricting the thickness of the optical disc with the detachable module along at least one breaking line between the optical disc and the detachable module.

The injection moulding device in a further development of the invention also comprises a module restrictor for restricting the thickness of the detachable module. The module being optionally intended for receiving an electronic circuit.

In an even further embodiment of the invention the mould is a standard mould for standard optical discs and the injection moulding device comprises in addition an insert insertable into the standard mould. The insert inside the standard mould restricts the internal dimensions of the cavity of the mould in order to shape the optical disc with detachable module differently from standard optical discs.

Preferably, the at least one line restrictor is comprised by a plunger moveable into the cavity of the mould, preferably in a direction approximately orthogonal to the optical disc. The at least one line restrictor is intended to be moved into the cavity of the mould, after having supplied moulding polymer into the cavity and before this polymer hardens.

A line restrictor is preferably provided with a tapering form having a taper angle of less than 15 degrees, preferably less than 12 degrees and most preferably less than 10 degrees on the side that is facing the module.

The taper angle facing the module should be rather small if the module is desired with very well defined dimensions and steep side edges. The latter is especially important for modules like SIM plugs.

The taper angle facing away from the detachable module is preferably larger than the taper angle facing the module and should be more than 8 degrees, preferably more than 10 degrees and most preferably more than 12 degrees.

Generally, the taper angles should not be chosen too small. The reason is that for very small taper angles, the polymer that forms the optical disc with detachable module after hardening may have contracted so much around the line restrictor during the hardening process that the optical disc with detachable module cannot be removed from the mould without receiving gratings in the groove for the breaking line. Because the taper angle towards the module, especially when this module is a SIM plug has to be rather small, it is preferred that the taper angle facing away from the module is rather large, for example 20-30 degrees. This way, while being steep towards the detachable module, for example a SIM plug, the line restrictor may be so blunt that the groove for the breaking may not fasten on the line restrictor.

In case that the line restrictor is not comprised by a plunger and the line restrictor instead is a non-movable feature of the mould form or of the insert in the mould form, the line restrictor should be blunt for another reason. In case that the taper angles towards the module and facing away from the module are small, the line restrictor will be sharp and thin as a knife edge. This again implies that the thin line restrictor may more easily be deformed when polymer under high pressure is passing the narrow passage between the line restrictor and the opposite side of the mould. Partly, this can be prevented by using very hard materials, as for instance tungsten carbide, however, steel may be desired as a material for the line restrictor by other reasons. Generally, the shape of the line restrictor may be designed in dependence of the viscosity of the polymer and the distance between the line restrictor and the opposite side of the mould cavity.

The method of production of an optical disc with detachable module may result in a product being an optical disc with a detachable SIM plug, and said optical disc with SIM plug having a length of approximately 85.6 mm and a width of approximately 54 mm, the SIM plug being placed on a position corresponding to ISO 7810 standard, a diagonal of the optical disc being at least 80 mm, and a skew edge of the SIM plug facing away from the optical disk.

The detachable module may be a SIM plug for telephones as described above, for example with GSM, GPRS or UMTS standard, but may also be a pay card to be installed into a mobile phone in order to be able to pay for goods or services with the mobile phone. Applications in connection with road pricing or intelligent surveillance of buildings or working machines are other possibilities. Alternatively, the detachable module is a general computer component, for example a memory type or processing unit type as ROM, RAM, or CPU.

The user may, thus access the data information of the optical disc in order to learn about the module and its installation. The data information on the optical disc may also comprise a company profile of the producer or distributor, software drivers necessary for the installation of the microelectronics module, computer programs, software packages necessary for Internet access from a mobile or stationary telephone, purchase contracts, licenses, television receiver codes, or any other relevant information for the user.

The invention will be explained in more detail in the following with reference to the drawings.

### SHORT DESCRIPTION OF THE DRAWINGS

FIG. 1 shows a standard mould form and an insert,

FIG. 2 shows one embodiment of the optical disc and detachable module,

FIG. 3 shows alternative embodiments,

FIG. 4 shows possible embodiments of the line restrictor in cross section,

FIG. 5 shows a cross-sectional view of the insert inside the mould,

FIG. 6 shows a further embodiment of the Invention with two modules,

FIG. 7 shows an embodiment with a SIM plug,

FIG. 8 shows an embodiment with a SIM plug In a 7810 standard,

FIG. 9 shows an even further embodiment with two modules.

### DETAILED DESCRIPTION OF THE INVENTION

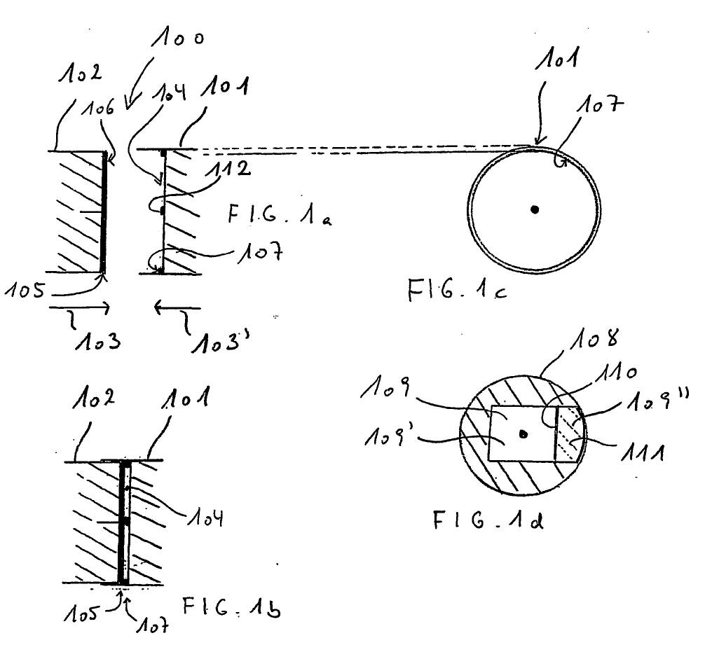

FIG. 1a shows a standard mould form 100 with a first 101 and second 102 mould section that can be moved—as indicated by arrows 103, 103′—relative to one another between an open and a closed position. In the closed position, as illustrated in FIG. 1b, a mould cavity 104 is defined into which a molten polymer is injectable to form the disc with detachable module. A stamper 105 in the mould cavity 104 has a surface 106 towards the interior of the cavity 104, said surface 106 having a surface structure being the counterpart for the corresponding surface structure of the moulded optical disc. In the closed situation as illustrated in FIG. 1b, the stamper 105 rests on a central disc 112 defining the center of rotation for the optical disc and on a ring 107, which defines the outer periphery of the final optical disc moulded in the cavity 104.

The first section 101 of the mould is shown in a head-on perspective In FIG. 1c.

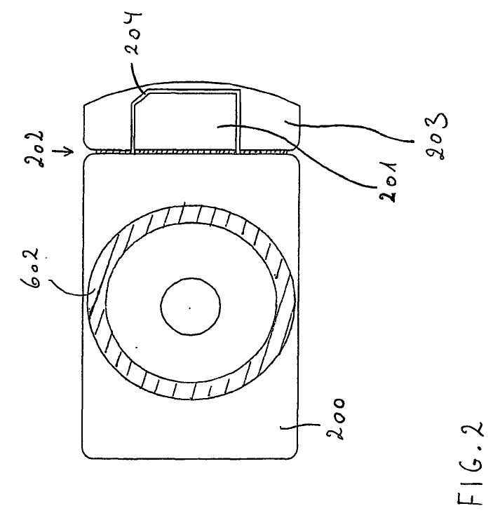

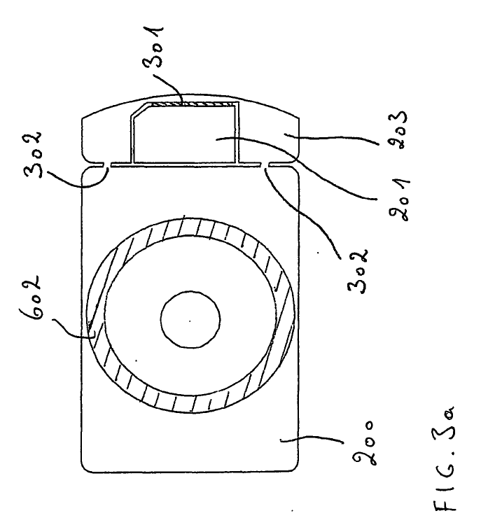

In order to produce optical disks with detachable modules according to the invention, an insert 108, as shown in FIG. 1d, may be fittingly inserted into the cavity 104. The remaining internal volume 109 defines the dimensions of the optical disk with detachable module. Such an optical disc 200 with detachable module 201 is shown in a possible embodiment in FIG. 2.

Now, referring to FIG. 1d, the insert 108 may be provided with a module restrictor 111 that defines the space 109″ for the detachable module 201 thinner, for example 0.8 mm or 0.85 mm, than the space for the optical disk 109′ with a larger thickness, for example 1.2 mm. The thickness of the module 201 may be restricted from either side, eventually from both sides. However, it is preferred that the thickness is restricted from the side opposite to the stamper such that the module 201 rests against the stamper surface.

The insert 108 may comprise a line restrictor 110 for restricting the thickness of the optical disc 200 with detachable module 201 along at least one breaking line 202 between the optical disc 200 and the detachable module 201 as shown in FIG. 2. For protection of the edge of the detachable module 201, a frame 203 may be connected to the optical disc 200. This frame 203 need not to be detachable from the disc 200, but this is preferred due to reasons of weight symmetry when reading the optical disk 200 in an appropriated reading unit.

In FIG. 5, the line restrictor 110 is shown in a cross section perspective together with part of the stamper 105 and the opposite side 113 of the cavity 104. The line restrictor 110 is optionally a part of the insert 108. Alternatively, the line restrictor 110 is a plunger 110′ as it is indicated with hatched outlines, such that the line restrictor 110 can be moved at least partly but preferably totally in and out of the cavity 104.

As shown in FIG. 2, a space between the frame 203 and the detachable module 201 may also be provided by corresponding structures on the insert 108. Alternatively, this space 204 or these spaces may be produced by one or more plungers inserted into the cavity 104 after having filled polymer into the cavity 104. A further, however not preferred, possibility, is to stamp or mill these spaces out of the moulded disc 200 with detachable module 201.

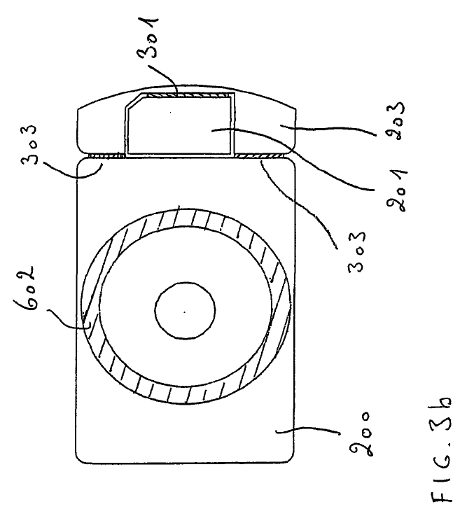

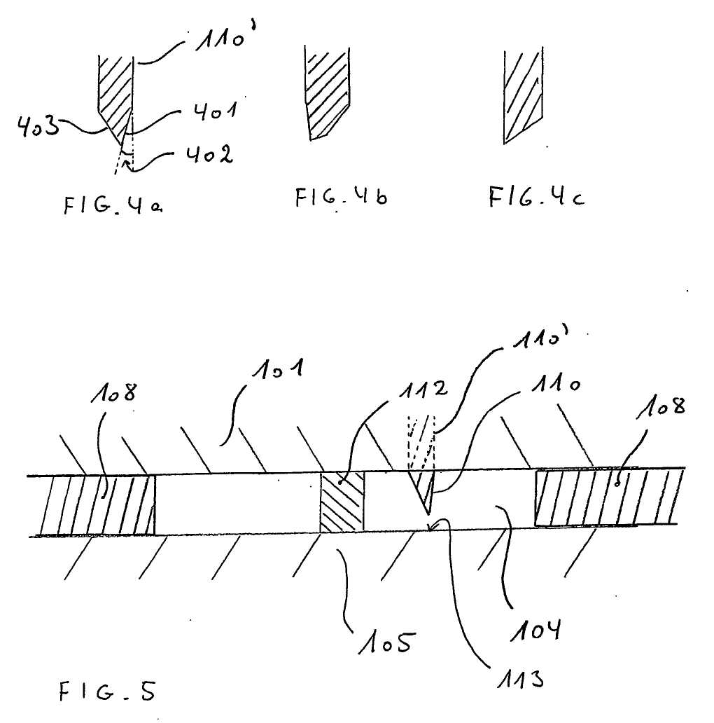

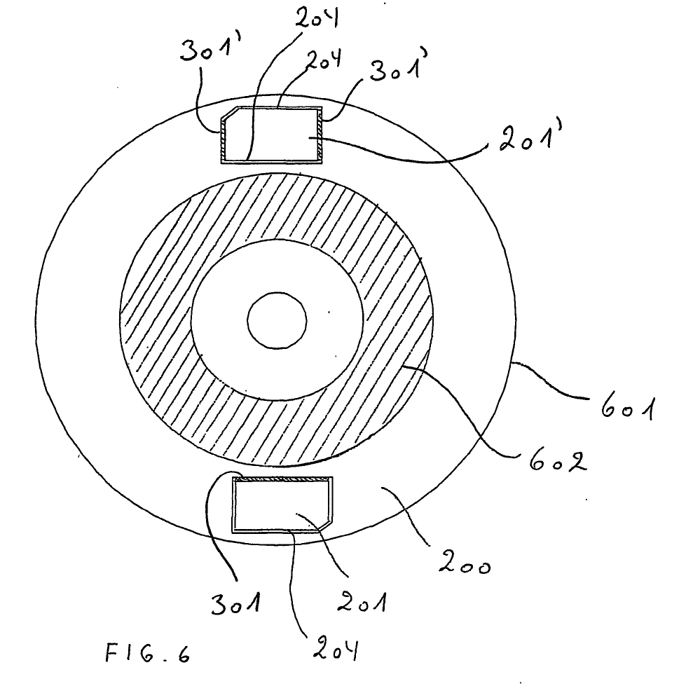

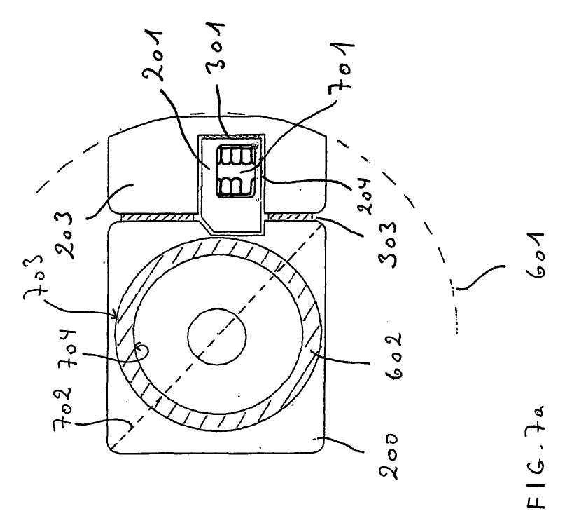

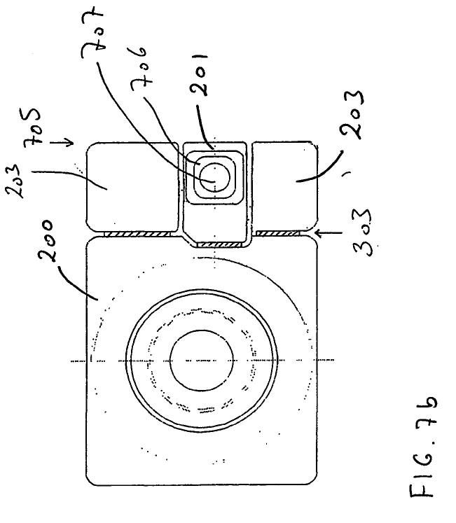

Smaller sections of grooves for breaking lines may be provided, for example, as shown in FIG. 3, where the groove for the breaking line 301 between the optical disk 200 and the detachable module 201 may actually be provided between the frame 203 and the detachable module 201. The detachable module 201 may in this case be detached from the frame 203, which, in principle could remain as part of the optical disk 200.

The frame 203 can be attached to the optical disk 200 with a number of bridges 302 as shown in FIG. 3a or, alternatively, with grooves 303 along breaking lines as shown in FIG. 3b which take the place of the bridges.

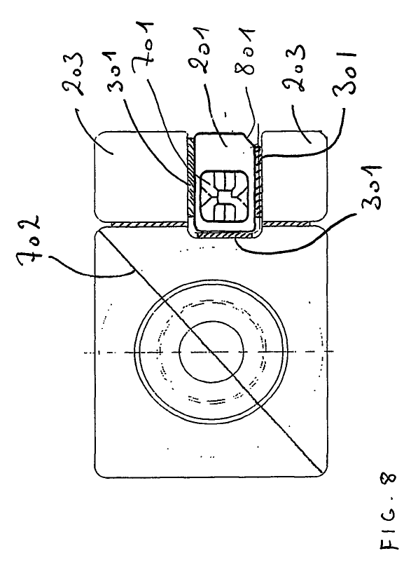

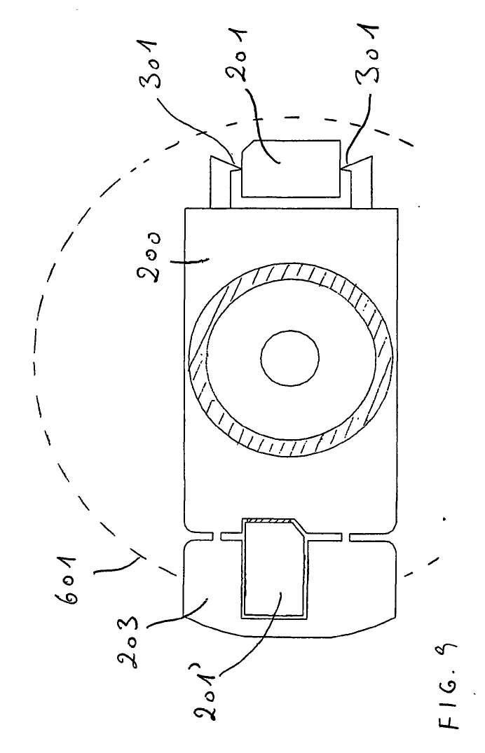

The line restrictor 110 may be provided as a wedge, as shown in FIG. 4, where one side 401 of the line restrictor 110′ has a smaller taper angle 402 than other side 403. The side 401 with the smaller taper angle is usually used for edges that have to be steep, like it is preferred for SIM plugs. The less steep side on the wedge is used in order to provide a restrictor which is blunt enough so that the optical disk will not fasten to the line restrictor. Usually the edge of the optical disk is not necessarily steep.

If the detachable module 201 and the optical disk 200 both are desired with steep edges, the embodiment of FIG. 3b is preferred. The groove 301 for the breaking line between the detachable module 201 and the frame 203 may be constructed to be steep on the edge of the detachable module 301 and less steep on the frame. On the other hand, the grooves 303 for the breaking lines between the frame 203 and the optical disk 200 may be constructed such that the optical disc 200 has a steep edge.

Other examples for possible shapes for line restrictors are shown in FIGS. 4b and 4c.

In FIG. 6, an alternative approach is shown. In this case, the optical disk 200 has a circular dimension 601 and comprises two detachable modules 201, 201′. The detachable modules 201, 201′ are connected to the optical disc 200 by grooves 301, 301′ along breaking lines and are otherwise surrounded by open spaces 204.

Limited by the placement of the modules 201, 201′ on FIG. 6 are the tracks 602 of the optical disk 200. In contrast, for the embodiments shown in FIG. 2 and FIG. 3, the tracks 602 are limited by the outer dimension of the optical disk 200.

In FIG. 7a an embodiment is shown, where the position of the detachable module 201 with respect to the tracks 603 of the optical disc 200 is analogous to one of the shown embodiments as disclosed In International patent application WO 01/18750 by Lüke assigned to Orga. If the position of the SIM module is as required by ISO 7810 standard, the tracks 602 of the optical disk 200 are limited by the outer diameter 703 that is defined by the SIM module. For standard disk drives for reading CD-ROMs, where also a minimum diameter 704 is given for the reading the tracks 603, the space between the inner diameter 704 and the outer diameter 703 is almost negligible, leaving practically no space for data storage. Thus, this embodiment is not suited for standard CD-ROM drives or standard music CD drives, if the ISO standard 7810 is to be followed.

However, the shown embodiment on FIG. 7a has an advantage over the disclosure in International patent application WO 01/18750 by Lüke assigned to Orga, because the diameter 702 of the optical disc 200 is at least 80 mm, such that the diameter of the optical disc does not prevent readability in standard disc reading units.

If the placement of the SIM plug should not exactly correspond to the ISO 7810 standard, the SIM plug 201 may be placed at the edge as shown in FIG. 7b. This way, the SIM plug 201 does not limit the tracks 602 of the optical disc 200. Visible in this drawing is also the hollow 706 for the electronic circuit and the even deeper hollow 707 for the glue.

In case that the optical disc together with the detachable module shall correspond to the ISO 7810 standard with a length of 85.6 mm and a width of 53.9 mm, a certain embodiment as shown on FIG. 8 has turned out to be of great advantage. The detachable module 201 as shown is a SIM plug with an electronic circuit 701 with a position that fulfills the ISO 7816 standard. Thus, the SIM module 201 is connected such to the optical disk 200 that existing standard machines can be used for placing the electronic circuit 701 into the hollow in the SIM module 201. This reduces the production costs for the optical disk 200 with SIM module 201 according to the invention. However, though the position of the electronic circuit is correct, the programming of the connectors are changed, because the DIM plug 201 is turned 180 degrees as compared to standard configurations, where the standard configuration is shown in FIG. 7, that is to say with the skew edge 801 of the SIM plug is facing away from the optical disk. This different programming by existing standard machines can be achieved by only minor modifications to these machines, the modifications being far less extensive than changing the placement of the module 201 itself.

The placement of the SIM module 201 as shown in FIG. 8 still leaves space enough for the tracks 602 of the optical disk to contain sufficient data for the user of the optical disk.

The embodiment on FIG. 8 furthermore Implies that the diagonal 702 of the optical disk 200 is at least 80 mm such that it is assured that the optical disk 200 is playable in all corresponding standard reading units.

In the shown embodiments in FIG. 2, 3 6, 7, and FIG. 8, the location of the microelectronics module 200 is within the periphery 601 of typical circular CD-ROMs and, therefore, inside the maximum diameter, 12 cm, acceptable by a CD-ROM reading unit. Such a CD-ROM may be read before or after detachment of the microelectronics module. For instance, a user may read the information of the optical disk in his CD-reading unit prior to detaching of the SIM plug 201 for installation in a mobile phone. In this case, the user may study the information on the optical disk 200, before the user actually decides to use the SIM plug 201 in the user's telephone. After detachment of the SIM plug 2, the user may still read the information which may be related to the installation and the set-up of the telephone, once the SIM plug 201 is inserted into the mobile phone.

The possibility to read the information on the optical disk 201 before detachment of the microelectronics module 201, for example a SIM plug or another computer component, may be important for the user in case he wants to read the information in order to find out, whether he actually wishes to purchase the module 201. On the other hand, the possibility to read the information after detachment may be important for the user in case that the information is Important during the user's installation of the module 201, where the Installation can be a number of difficult steps.

FIG. 9 shows a further embodiment of an optical disk that is a carrier card with optical disk 200 and with two detachable modules 201 and 201′, which, for example, may be microelectronics modules like SIM plugs. One of the modules 201 is inside the periphery 601 typical for circular CD-ROMs and therefore inside the maximum diameter acceptable by a CD-ROM reading unit, while the other microelectronics module 201′ is partly outside periphery 601 typical for circular CD-ROMs and may be outside the maximum diameter acceptable by a CD-ROM reading unit. In order to read the optical disk 200 in a CD-ROM drive, it is necessary to remove the second microelectronics module 201′. In case that the user after purchase of the optical disk 200 wants to return the optical disk 200 to the seller, this may be used as a safe and easy control for the seller whether the CD-ROM 200 has been read.

Because the embodiment as shown on FIG. 8 has outlines that exceed the normal standard for optical disks, the production of such an embodiment may require modification of existing mould devices.

It is possible to form optical disks 200 with a variety of different shapes, for example polygonal, star-shaped, or oval, which may be used to catch the attention of the user when the user is visiting a seller's place and has to chose among a number of offers.

A frame 203 as shown in FIGS. 2 and 7 may function as a carrier component that Is provided with a shape appropriate for the device of interest into which the module 201 has to be installed. Thus, the frame 203 may function as an adapter in an analogue way as telephone SIM cards, where the carrier SIM card-fulfilling the ISO 7810 standard with the SIM plug 201 may be installed in some cellular telephones, while the SIM plug 201 itself may be detached from the carrier SIM card for installation into other cellular telephones.

In FIG. 9, one detachable module 201′ is attached to the carrier card with optical disk 200 with bridges 301. Alternatively, this detachable module 201′ may be attached to the optical disk along one or several perforated lines. Such bridges 301 or perforated lines may be produces by the above described plunger principle, though also the insert 105 in the mould cavity 104 may be constructed such that plungers may be avoided.

1-19. (canceled)

20. An optical disc with a detachable module, said optical disc with detachable module having
a length of approximately 85.6 mm and a width of approximately 54 mm,
the SIM plug being placed on a position corresponding to ISO 7810 standard
a diagonal of the optical disc being at least 80 mm, and
a skew edge of the SIM plug facing away from the optical disk.

21. An optical disc with a detachable module according to claim 20, where the optical disc and the detachable module are divided by a groove along a breaking line, and where said groove along the breaking line is tapered from being less steep to being more steep seen in a direction from the optical disc towards the detachable module.

22. An optical disc with a detachable module according to claim 20, where a frame is provided in connection with the optical disc and the detachable module, where the frame and the detachable module are divided by grooves along breaking lines, and where said grooves along breaking lines are tapered from being less steep to being more steep seen in a direction from the frame towards the detachable module.

23. An optical disc with a detachable module according to claim 20, where a frame is provided in connection with the optical disc and the detachable module, where the frame and the optical disc are divided by grooves along breaking lines, and where said grooves along breaking lines are tapered from being less steep to being more steep seen in a direction from the frame towards the optical disc.

24. An optical disc with a detachable module, said optical disc with detachable module having
a length of approximately 85.6 mm and a width of approximately 54 mm,
the SIM plug being placed on a position differing from ISO 7810 standard
a diagonal of the optical disc being at least 80 mm, and
a skew edge of the SIM plug facing towards the optical disk.

25. An optical disc with a detachable module according to claim 24, where the optical disc and the detachable module are divided by a groove along a breaking line, and where said groove along the breaking line is tapered from being less steep to being more steep seen in a direction from the optical disc towards the detachable module.

26. An optical disc with a detachable module according to claim 24, where a frame is provided in connection with the optical disc and the detachable module, where the frame and the detachable module are divided by grooves along breaking lines, and where said grooves along breaking lines are tapered from being less steep to being more steep seen in a direction from the frame towards the detachable module.

27. An optical disc with a detachable module according to 24, where a frame is provided in connection with the optical disc and the detachable module, where the frame and the optical disc are divided by grooves along breaking lines, and where said grooves along breaking lines are tapered from being less steep to being more steep seen in a direction from the frame towards the optical disc.

28. Method for production of an optical disc with a detachable module comprising
providing a mould with mould cavity having internal dimensions corresponding to the dimensions of the optical disc with the detachable module, said mould having supplier means for supplying molten polymer into the mould cavity,
providing a stamper in the mould cavity, said stamper having a surface towards the interior of the mould cavity, said surface having a surface structure being the counterpart for the corresponding surface structure of the moulded optical disc,
supplying molten polymer into the mould cavity, said molten polymer filling the remaining space inside the mould cavity, cooling the polymer to a temperature where the polymer is hardened, and removing the moulded optical disc,
providing at least one line restrictor, for restricting the thickness of the optical disc with detachable module along at least one breaking line between the optical disc and the detachable module, and
providing the at least one line restrictor in the mould at a position between the optical disc and the detachable module for expanding a longitudinal dimension of the optical disc to a dimension of at least 59,1 mm.

29. Method according to claim 28, wherein said method also comprises providing at least one module thickness restrictor for restricting the thickness, preferably between 0.8 mm and 0.85 mm, of the detachable module over at least an area that is intended to include an electronic circuit.

30. Method according to claim 28, wherein said at least one line restrictor is comprised by at least one movable plunger and that the method comprises moving said at least one plunger into the mould cavity after having supplied said molten polymer and before said polymer hardens.

31. Method according to claim 28, wherein said method comprises providing a mould with internal dimensions corresponding to the dimensions of the optical disc with the detachable module comprises providing a standard mould for a standard optical disc and providing an insert insertable into said standard mould, said insert inside said standard mould restricting the internal dimensions of the mould cavity for shaping the optical disc into dimensions different from a standard optical disc.

32. Method according to claims 28, wherein said method further comprises providing said detachable module with a hollow for an electronic circuit during moulding of said optical disc, and after removal of said disc, providing a standard production machine for inserting an electronic circuit into said hollow.

33. Method according to claim 28, wherein the optical disc after moulding is provided with a reflective layer and covered by spray coating or silk-screen printing.

34. Method according to claim 28, wherein said method also comprises providing at least one mould cavity restricting the dimensions between a length of approximately 85.6 mm and a width of approximately 54 mm, of the optical disc with the detachable module.

35. An injection moulding device for manufacturing an optical disc with a detachable module from a polymer material, said injection moulding device comprising
a mould having a first and second mould section which are movable relative to one another between an open and a closed position, and between which in the closed position a mould cavity is defined into which a molten polymer is injectable to form the disc with detachable module,
a stamper in the mould cavity having a surface towards the interior of the cavity, said surface having a surface structure being the counterpart for the corresponding surface structure of the moulded optical disc, and
said injection moulding device also comprising at least one line restrictor, for restricting the thickness of the optical disc with detachable module along at least one breaking line between the optical disc and the detachable module, and
wherein said line restrictor is provided with a tapering form with a taper angle facing towards the module of less than 15 degrees, preferably less than 12 degrees.

36. An injection moulding device according to claim 35, wherein said device also comprises a module thickness restrictor for restricting the thickness, preferably between 0.8 mm and 0.85 mm, of the detachable module, said module being optionally intended for receiving an electronic circuit.

37. An injection moulding device according to claim 35, wherein said device also comprises a mould cavity restricting the dimensions between a length of approximately 85.6 mm and a width of approximately 54 mm, of the optical disc with the detachable module.

38. An injection moulding device according to claim 35, wherein said mould is a standard mould for standard optical discs, and wherein said injection moulding device also comprises an insert insertable into said standard mould, said insert inside said standard mould restricting the internal dimensions of the cavity for shaping the optical disc with detachable module differently from a standard optical disc.

39. An injection moulding device according to claim 35, wherein said at least one line restrictor is comprised by at least one plunger movable into the cavity of the mould, preferably in a direction approximately orthogonal to said optical disc, said line restrictor being intended to be moved into the cavity of the mould after having supplied molten polymer into the cavity and before said polymer hardens.

40. An injection moulding device according to claim 35, wherein said taper angle facing away from said module is larger than said taper angle towards said module.

41. An injection moulding device for manufacturing an optical disc with a detachable module from a polymer material, said injection moulding device comprising
a mould having a first and second mould section which are movable relative to one another between an open and a closed position, and between which in the closed position a mould cavity is defined into which a molten polymer is injectable to form the disc with detachable module,
a stamper in the mould cavity having a surface towards the interior of the cavity, said surface having a surface structure being the counterpart for the corresponding surface structure of the moulded optical disc, and
said injection moulding device also comprising at least one line restrictor, for restricting the thickness of the optical disc with detachable module along at least one breaking line between the optical disc and the detachable module, and
wherein said line restrictor is provided with a tapering form with a taper angle facing away from the module of more than 8 degrees, preferably more than 10 degrees and most preferably more than 12 degrees.

42. An injection moulding device according to claim 41, wherein said device also comprises a module thickness restrictor for restricting the thickness, preferably between 0.8 mm and 0.85 mm, of the detachable module, said module being optionally intended for receiving an electronic circuit.

43. An injection moulding device according to claim 41, wherein said device also comprises a mould cavity restricting the dimensions between a length of approximately 85.6 mm and a width of approximately 54 mm, of the optical disc with the detachable module.

44. An injection moulding device according claim 41, wherein said mould is a standard mould for standard optical discs, and wherein said injection moulding device also comprises an insert insertable into said standard mould, said insert inside said standard mould restricting the internal dimensions of the cavity for shaping the optical disc with detachable module differently from a standard optical disc.

45. An injection moulding device according to claim 41, wherein said at least one line restrictor is comprised by at least one plunger movable into the cavity of the mould, preferably in a direction approximately orthogonal to said optical disc, said line restrictor being intended to be moved into the cavity of the mould after having supplied molten polymer into the cavity and before said polymer hardens.

46. An injection moulding device according to claim 41, wherein said taper angle facing away from said module is larger than said taper angle towards said module.

47. An insert insertable into a standard mould with cavity for moulding of standard optical discs, said insert inside said standard mould restricting the internal dimensions of the cavity for shaping an optical disc with detachable module differently from a standard optical disc, and said insert being fittingly inserted into the cavity of the standard mould.
